(19) United States
(12) Patent Application Publication
(10) Pub. No.: US 2005/0224311 A1
(43) Pub. Date: Oct. 13, 2005

(54) [BANKNOTE-VALIDATING MACHINE EQUIPPED WITH SECURITY DEVICE]

(75) Inventor: Wen-Hsien Tsai, TAIPEI (TW)

Correspondence Address: INTERNATIONAL CURRENCY TECHNOLOGIES CORPORATION, 2F-4. NO. 148, SEC. 4, CHUNG HSIAN EAST ROAD, TAIPEI, TW

(73) Assignee: INTERNATIONAL CURRENCY TECHNOLOGIES CORPORATION, TAIPEI (TW)

(21) Appl. No.: 10/709,088

(22) Filed: Apr. 13, 2004

(51) Int. Cl. G07C 3/00; G07F 9/02; G07D 7/00

(52) U.S. Cl. 194/203

(57) ABSTRACT

A banknote-validating machine equipped with security device is provided. The security device is installed inside the banknote receiver of the banknote-validating machine. The banknote receiver has an upper chassis and a lower chassis, and a banknote channel is formed between the upper chassis and the lower chassis. The distal end of the banknote channel is conjoint to the inner part of the banknote entrance slot on the front panel. A sensor is positioned at a primal end of the banknote channel. A security plate is positioned at the upper chassis. The sensor is adapted for sensing the length of the banknote entering banknote channel and the time taken for the banknote to pass the banknote channel. The security plate is adapted for blocking the banknote. Thus, the security device has multiple security functions for preventing the banknote from being pulled out by an external force.

### BACKGROUND OF INVENTION

The present invention is generally related to a banknote-validating machine equipped with security device, and more particularly to a banknote-validating machine equipped with security device having multiple security passes set inside the banknote channel of the banknote receiver capable of substantially preventing the banknote from being pulled out by an external force.

With the advancement of technologies, the vending machines installed in the public places for providing convenience and prompt service to the public, for example, tickets, coin exchange and so on. Vending machines are not only advantageous for cutting down the labor cost but also highly acceptable because of the convenience provided. Generally, the vending machine is unsupervised at most of time except during maintenance or refilling the merchandize supplies therein. During unsupervised period of time, users may try to steal the money within the vending machine. Sometimes, some users may exchange coins or retrieve cards or tickets from the vending machines without actually paying for it. One common way of stealing is to attach a string or attach a soft long strip of film to a distal end of the banknote and then insert the banknote into the banknote entrance slot, and after the transaction of the deal is successful, the user pulls out the banknote by pulling the string or the long strip of film attached to the distal end of the banknote. Accordingly, the stealing activity could cause an unimaginable loss to the vending machines owners.

To prevent the above loss, the conventional banknote-validating machine is equipped with a frame A. Referring to FIG. 9, a cross sectional side view of a conventional banknote-validating machine is show. The frame A has a bill entrance slot Al at a side thereof, and inside the frame A, a circuit board B for identifying the banknote and a roller set C are set at an upper and a lower side of the banknote channel respectively. A hook D is set at the exit A2 of the banknote channel for preventing the banknote from being pulled out after the banknote enters the banknote entrance slot A1. However, because the banknote is soft, and therefore when it is forcibly pulled, the banknote could get easily damaged and also this could jam the banknote entrance slot Al and breakdown the vending machine. Further, the abovementioned security function will lose its effectiveness when the user use a hard material, for example, steel string or a metallic plate, or a strip of soft film such as an adhesive tape, a thin cardboard, a film or the like, to pull the banknote. Therefore, the above conventional security has several defects, and how to improve the banknote-validating machine with better security has become the important issue for the manufacturers of this industry.

### SUMMARY OF INVENTION

Accordingly, in the view of the foregoing, the present inventor makes a detailed study of related art to evaluate and consider, and uses years of accumulated experience in this field, and through several experiments, to create a new security device of a banknote-validating machine. The present invention provides an innovated cost effective security device of a banknote-validating machine.

According to an aspect of the present invention, the banknote-validating machine comprises a banknote receiver and a security device installed inside the banknote receiver. The banknote receiver comprises an upper chassis and a lower chassis, and a banknote channel is formed between the upper chassis and the lower chassis. The distal end of the banknote channel is conjoint to the inner part of the banknote entranceon a front panel. A sensor is positioned at a primal end of the banknote channel. A security plate is positioned at the upper chassis. The sensor is adapted for sensing the length of the banknote entering banknote channel and the time taken for the banknote to pass the banknote channel. The security plate is adapted for blocking the banknote. Thus, the security device has multiple security functions for effectively preventing the banknote from being pulled out by an external force.

According to another aspect of the present invention, the sensor installed in the upper chassis is adapted for sensing the length of the banknote, and if the banknote exceeds the standard length, the sensor is capable of issuing a signal for ejecting the banknote out of the banknote entrance slot of the banknote-validating machine.

According to another aspect of the present invention, the security device of the banknote receiver comprises a security plate, which has a plurality of hooks.

According to another aspect of the present invention, the plurality of arrow shaped long and short hooks, and the long and short hooks are arranged alternately.

### BRIEF DESCRIPTION OF DRAWINGS

For a more complete understanding of the present invention, reference will now be made to the following detailed description of preferred embodiments taken in conjunction with the following accompanying drawings.

FIG. 1 is the elevational view of a banknote-validating machine equipped with security device according to an embodiment of the present invention.

FIG. 2 is the exploded view of a banknote-validating machine equipped with security device according to an embodiment of the present invention.

FIG. 3 is the back elevational view of a banknote-validating machine equipped with security device according to an embodiment of the present invention.

FIG. 4 is the back exploded view of a banknote-validating machine equipped with security device according to an embodiment of the present invention.

FIG. 5 is a cross sectional side view of a banknote-validating machine equipped with security device according to an embodiment of the present invention.

FIG. 6 is a cross sectional side view showing while the banknote reaches the roller within the banknote-validating machine equipped with security device according to an embodiment of the present invention.

FIG. 7 is a cross sectional side view showing while the banknote reaches the security plate within the banknote-validating machine equipped with security device according to an embodiment of the present invention.

FIG. 8 is the simplified circuit layout of a sensor of the banknote-validating machine equipped with security device according to an embodiment of the present invention.

FIG. 9 is the cross sectional side view of a conventional banknote-validating machine.

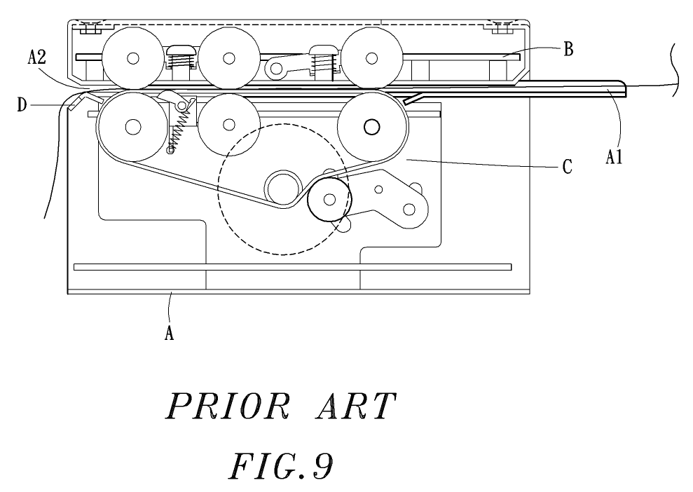

### DETAILED DESCRIPTION

Reference will be made in detail to the preferred embodiments of the invention, examples of which are illustrated in the accompanying drawings. Wherever possible, the same reference numbers are used in the drawings and the description to refer to the same or like parts.

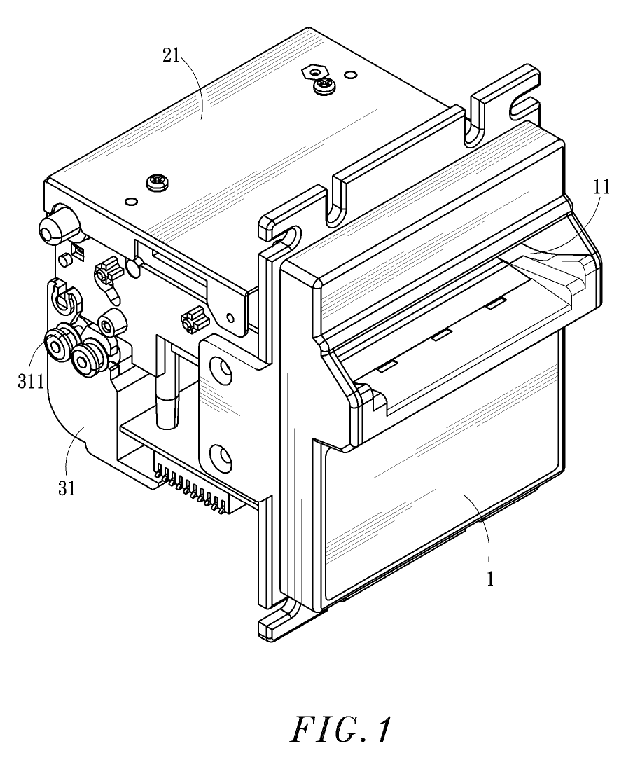

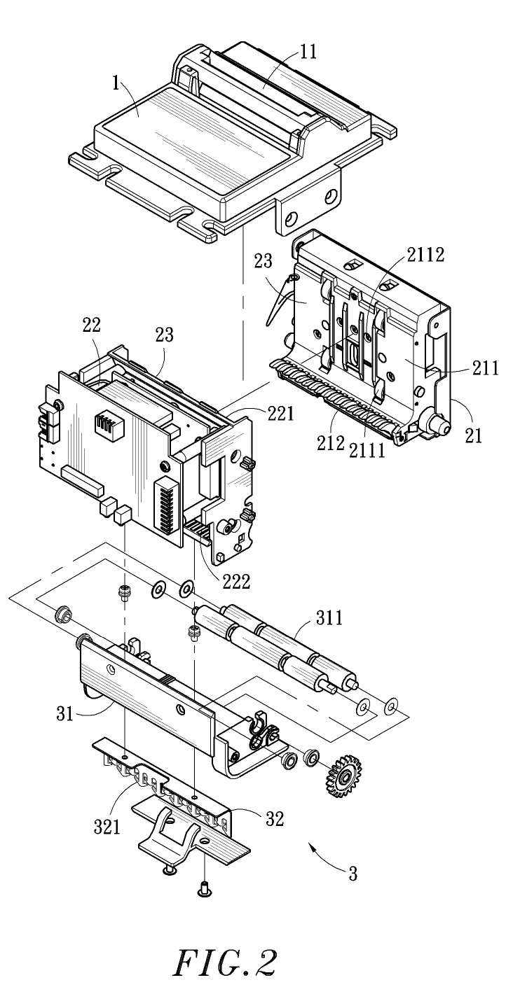

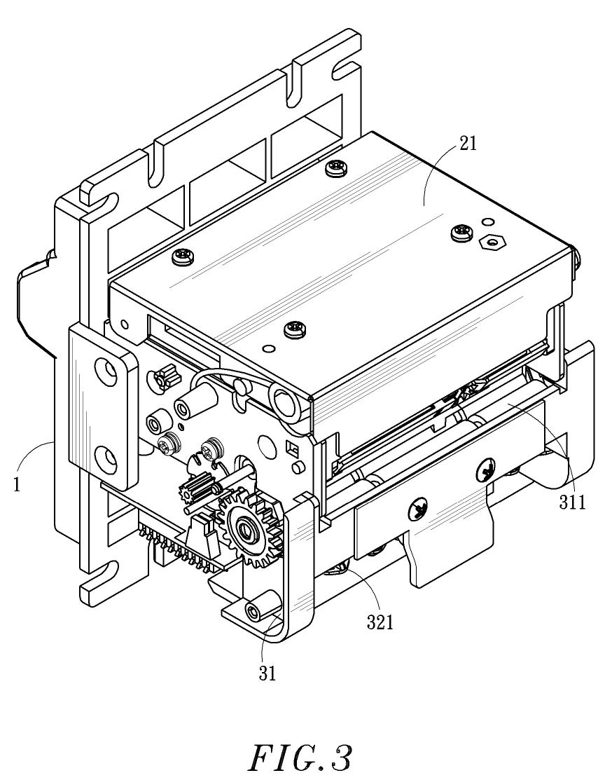

Referring to FIGS. 1, 2, 3 and 4, an elevational view, an exploded view, a back elevational view and a back exploded view of banknote-validating machine equipped with security device according to an embodiment of the present invention, are respectively shown. The banknote-validating machine comprises a front panel 1, a banknote receiver 2 and a security device 3. The front panel 1 comprises a banknote entrance slot 11.

The banknote receiver 2 comprises an upper chassis 21 and a lower chassis 22. A banknote channel 23 is formed between the upper chassis 21 and the lower chassis 22. An upper channel 211 disposed at a lower portion of the upper chassis 21 comprises pluralities of rollers 2111 and sensors 2112. A plurality of moveable buckling plates 212 is disposed at a side of the upper channel 211. A lower channel 221 disposed on a top of the lower chassis 22 comprises a plurality of transporting belt 221land a plurality of buckling holes 222 at a side thereof.

The security device 3 comprises a chassis 31 having a plurality of moveable directing rollers 311. A security plate 32 having a plurality of hooks 321 is set beneath the directing roller 311.

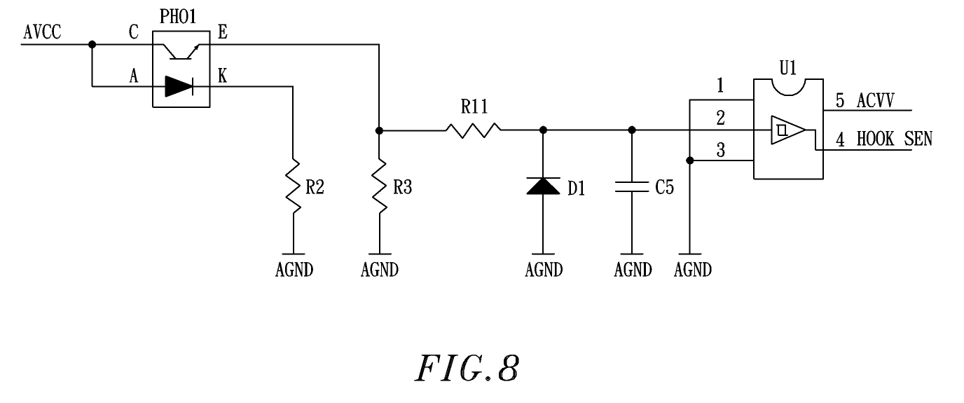

The banknote receiver 2 is conjoined by the upper chassis 21 and the lower chassis 22. The upper channel 211 of the upper chassis 21 and the lower channel 221 of the lower chassis 22 constitute the banknote channel 23. The distal end of the banknote channel 23 is conjoint to the inner part of the banknote entrance slot 11 on the front panel 1. The banknote channel comprises sensor 2112, a circuit layout of which is shown in FIG. 8. The sensor 2112 is adapted for detecting whether or not the entrance of the banknote 4 is under normal condition. The upper chassis 21 positioned at the primal end of the banknote channel 23 comprises a plurality of buckling plates 212 to buckle to the corresponding plurality of buckling holes 222. At the location where the buckling plates 212 buckle to the buckling holes 222, the security device 3 having the directing roller 311 is positioned beneath the buckling plates 212 and the buckling holes 222. The security plate 32 is set below the directing roller 311 to substantially secure the banknote 4 inside the banknote-validating machine.

When a user attaches a long soft strip of film, for example, an adhesive tape, a thin strip of cardboard, a film, and so on, on the banknote 4 and insert into the banknote channel 23, the aforementioned circuit of the sensor 2112 senses the time taken for the banknote 4 passing the plurality of buckling plate 212 and the buckling holes 222, and if the time for banknote 4 to pass thereof exceed the preset standard value, the circuit of the sensor 2112 issues a signal to reject the banknote 4 and the banknote 4 is ejected out of the banknote entrance slot 11 through the banknote channel 23.

Alternatively, the circuit of the sensor 2112 senses the number of rotation of the roller 2111 while the banknote 4 passes in the banknote channel 23, and if the number of rotations exceeds a preset standard value, the circuit of the sensor 2112 issues a signal to reject the banknote 4 and the banknote is ejected out of the banknote entrance slot 11 through the banknote channel 23.

The security plate 32 of the security device 3 comprises a plurality of hooks 321 arranged in an array comprised of long and short hooks that are alternately arranged. The hooks 321 have an arrow shape. Therefore, the gaps between the hooks 321 are small and therefore the hooks 321 are capable of preventing the banknote 4 being pulled back by any attached objects.

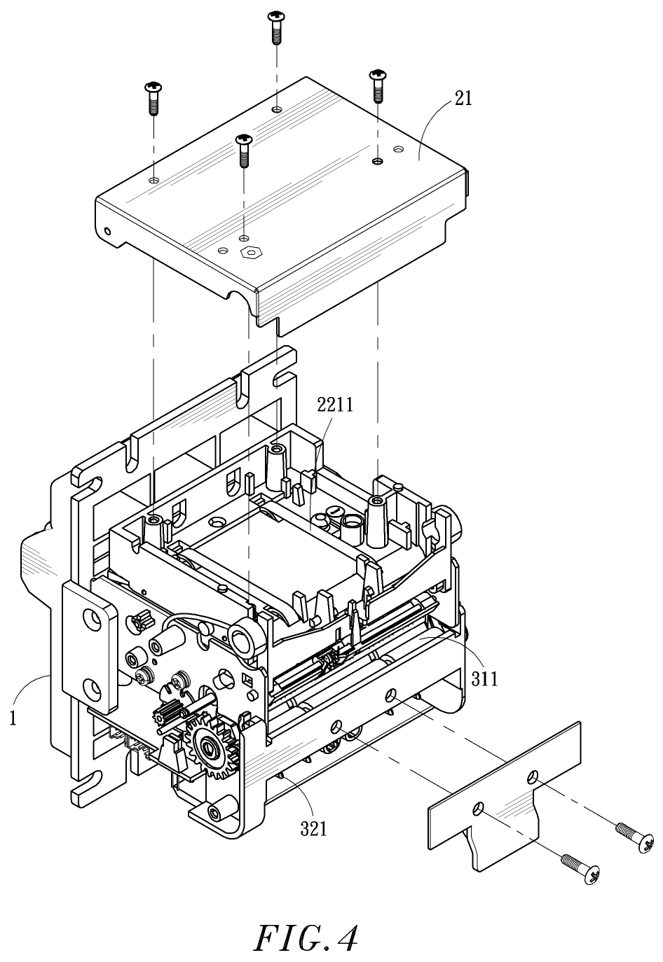

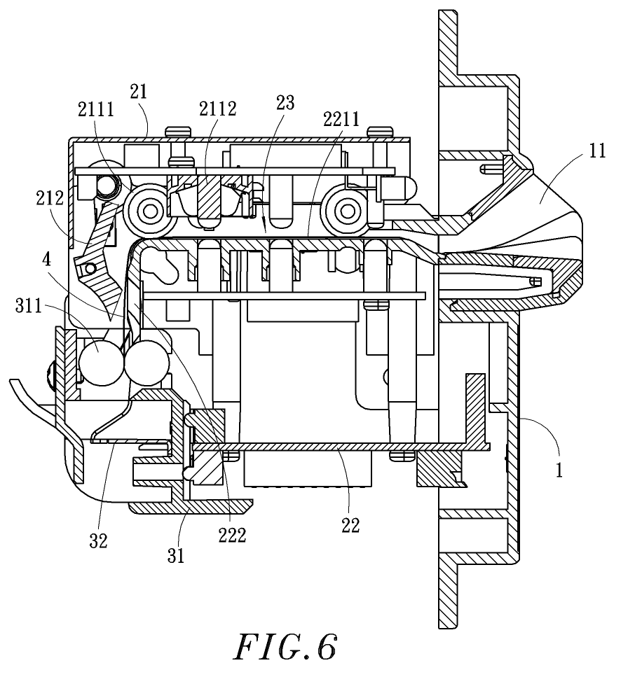

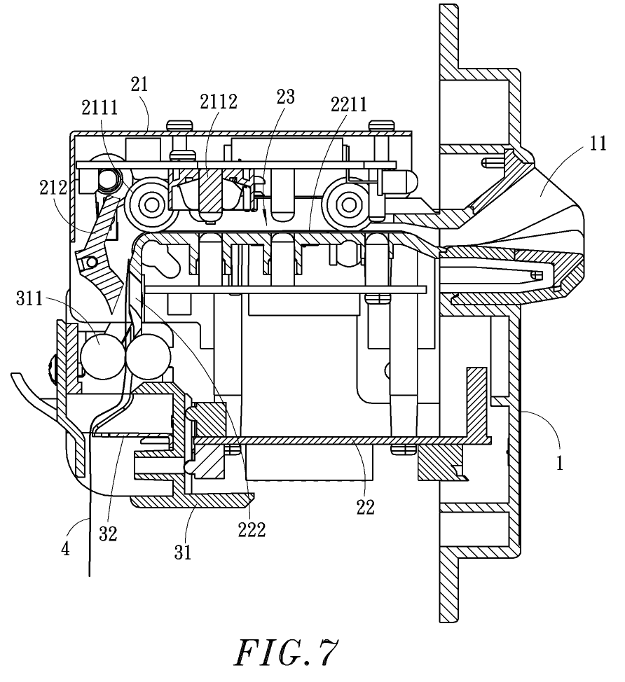

Referring to FIGS. 4, 5 and 6, a back exploded view, a cross sectional side view and a cross sectional side view showing while a banknote reaches the roller within a banknote-validating machine equipped with security device respectively according to an embodiment of the present invention. When inserting the banknote 4 into the banknote-validating machine of the present invention, the banknote 4 enters to the banknote channel 23 from the banknote entrance slot 11 on the front panel 1. Next, the sensor 2112 set inside the banknote channel 23 senses the banknote 4. The banknote 4 is clamped and transported by the roller 2111 and the transporting belt 2211 within the banknote channel 23. Meanwhile, the plurality of buckling plates 212 is lifted up and released from the corresponding plurality of buckling holes 222. The sensor 2112 senses the time taken or the number of rotations of the roller 2111 for the banknote 4 to pass thereby, and if the time taken or the number of rotations of the roller 2111 for the banknote 4 thereby is found to match with a preset value, the banknote 4 is allowed to pass between the plurality of buckling plates 212 and the plurality of buckling holes 222 as shown in FIGS. 6 and 7. On the other hand, if the banknote 4 carries any object attached, after the banknote 4 passes between the plurality of buckling plates 212 and the plurality of buckling holes 222, the directing roller 311 of the security device 3 clamps and forces the banknote channel 23 to form a vertical path to make the banknote 4 passthe security plate 32 positioned beneath the directing roller 311. Meanwhile, the plurality of hooks 321 of the security plate 32 forms a barricade to block the banknote 4 in order to prevent the banknote 4 from being pulled back by the attached object.

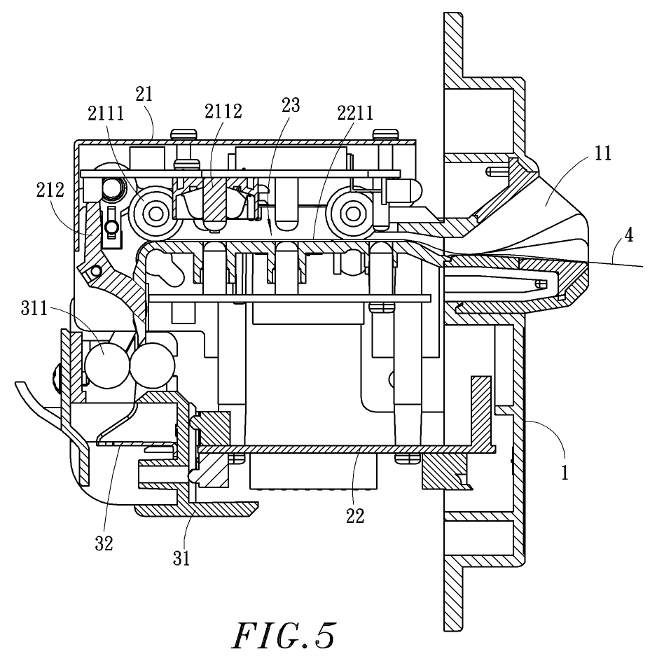

Referring to FIGS. 5, 6 and 7, a cross sectional side view, a cross sectional side view showing while a banknote reaches the roller and a cross sectional side view showing while a banknote reaches the security plate, within a banknote-validating machine equipped with security device according to an embodiment of the present invention. When the banknote 4 enters into the banknote channel 23 of the banknote receiver 2, the sensor 2112 senses the time taken or the number of rotations of the roller 2111, for the banknote 4 beginning from the banknote 4 entering the banknote entrance slot 11 until the banknote 4 passes between the plurality of buckling plates 212 and the buckling holes 222. If the sensor 2112 senses that the time taken or the number of rotations of the roller 2111 does not match with the preset value, the banknote 4 will be ejected out of the banknote entrance slot 11 through the banknote channel 23. After the banknote 4 passes the sensor 2112 and reaches the directing rollers 311, the plurality of arrow shaped hooks 321 of the security plate 32 can block the banknote 4 from being pulled out from the security plate 32. Thus the dual security functions described above could effectively the banknote 4 in the banknote channel 23 from being pulled out, and also damage to the banknote 4 by any external force can be effectively avoided.

Furthermore, if a user glues a plastic or soft strip, or ties a string to one end of the banknote 4, the sensor 2112 is capable of sensing such abnormal situation and reject the banknote 4 and ejects out the banknote 4 out of the banknote receiver 2. In the meantime, the plurality of buckling plates 212 is not released from the buckling holes 222 in order to block the banknote 4. And, when the banknote 4 passes the security plate 32, the attached object will get stuck between the plurality of hooks 321 of the security plate 32, and when the banknote 4 is pulled out by an external force, the hooks 321 cuts off or breaks the attached object. Thus, stealing of the accepted banknote can be effectively prevented.

The aforementioned banknote-validating machine equipped with security device of the present invention has at least the following advantages: i) The banknote channel has the sensor and the plurality of buckling plates alternately positioned with the plurality of buckling holes form the first security pass, and the second security pass of the securing plate ensure the banknote against being pulled out by the external force after the banknote enters the banknote channel.

ii) After the banknote inside the banknote channel of the bank-validating machine pass the plurality of buckling plates and buckling holes moving in a downward direction towards the directing roller, the directing roller forces the banknote to move vertically down and thereby making it increasingly difficult to pull out the banknote by the external force.

iii) The security plate of the security device comprises the plurality of arrow shaped hooks comprised of alternately arranged long-and-short hooks having a small gap therebetween in order to effectively block the banknote.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

1. A banknote-validating machine equipped with security device, comprising:
a banknote receiver; and
a security device comprising a security plate, installed in said banknote receiver, said banknote receiver comprising an upper chassis and a lower chassis, wherein a banknote channel is formed between said upper chassis and said lower chassis, wherein a distal end of said banknote channel is conjoint to an inner part of a banknote entrance slot on a front panel, a sensor and said security plate are disposed in said banknote channel, and wherein said sensor is adapted for sensing a length of a banknote and a time taken for said banknote to pass through said banknote channel and said security plate is adapted for blocking said banknote from being pulled out by an external force.

2. The banknote-validating machine equipped with security device according to claim 1, wherein said sensor comprises a circuit installed in said upper chassis for sensing said banknote within said banknote channel.

3. The banknote-validating machine equipped with security device according to claim 1, wherein said sensor is adapted for sensing a number of rotations of a roller set inside said banknote channel.

4. The banknote-validating machine equipped with security device according to claim 2, wherein said sensor is adapted for sensing a number of rotations of a roller set inside said banknote channel.

5. The banknote-validating machine equipped with security device according to claim 1, wherein said lower chassis comprises a plurality of buckling holes formed at a side thereof for buckling said buckling plates of the upper chassis and alternately positioned with said buckling plates.

6. The banknote-validating machine equipped with security device according to claim 1, wherein said security plate comprises a plurality of arrow shaped hooks.

7. The banknote-validating machine equipped with security device according to claim 1, wherein said hooks comprised of long and short hooks alternately arranged in an array.
